(19) United States
(12) Patent Application Publication
(10) Pub. No.: US 2007/0047270 A1
(43) Pub. Date: Mar. 1, 2007

(54) Load detector for an AC-AC power supply

(75) Inventors: Jun Makino, Hillview Park (SG); Boon Ghee Ting, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/218,401

(22) Filed: Sep. 1, 2005

(51) Int. Cl. H02J 3/00

(52) U.S. Cl. 363/34

(57) ABSTRACT

There is provided a load detector for determining whether a load is connected to an AC-AC power supply. The power supply comprises a transformer having a primary winding and a secondary winding, the primary winding being coupleable to an AC voltage supply via a switch, and the secondary winding being coupleable to a load. The load detector comprises a signal generator for generating a signal; a sensor for detecting the signal, the sensor being arranged to detect the signal if a load is coupled to the secondary winding and to not detect the signal if a load is not coupled to the secondary winding; and switch control circuitry coupled to the sensor and being arranged to keep the switch closed if the sensor is detecting the signal and to keep the switch open if the sensor is not detecting the signal. There is also provided an AC-AC power supply comprising such a load detector.

### FIELD OF THE INVENTION

The invention relates to a load detector for determining whether a load is connected to an AC-AC power supply and to an AC-AC power supply comprising such a load detector.

### BACKGROUND OF THE INVENTION

External power supply adaptors usually have two modes of operation: an active mode (in which the input of the power supply adaptor is connected to an AC power supply and the output is connected to a load) and a no-load mode (in which the input of the power supply adaptor is still connected to the AC supply, but no load is connected at the output). An example of an AC-DC external power supply adaptor is a charger for a mobile telephone. The charger is in active mode (to charge up the telephone) when the telephone is placed in the cradle for charging and is in no-load mode when the telephone is not in the cradle. An example of an AC-AC external power supply adaptor is a speaker for a personal computer (PC). When the PC speaker is switched on, it is in active mode and, when the speaker is switched off, this is equivalent to disconnecting the load, so the speaker is in no-load mode. Other examples can, of course, be envisaged. In active mode, the external power supply adaptor should ideally supply power to the load at high efficiency and, in no-load mode, minimal power should be expended—ideally just enough for the adaptor to switch back to active mode when a load is connected.

One known way to achieve low power consumption during no-load mode is to use a switching mode power supply (SMPS). However, an SMPS has drawbacks: a lot of switching noise is generated, the implementation can be costly and there may also be some limitations on the power consumption of an SMPS during no-load mode, especially if the load requires high power during active mode.

Another power supply design, which is simpler and less costly, is a linear power supply. An AC-DC linear power supply comprises a rectifier and filter capacitor on the secondary side of a transformer, whereas in an AC-AC linear power supply, the rectifier and capacitor are moved over to the load itself. However, in either case, because the AC power supply is still connected to the primary winding of the transformer, even when no load is connected at the output, there is still high power consumption during no-load mode. This problem has been partially solved by adopting a standby mode in which, when no load is connected on the secondary side of the transformer, the AC power supply is disconnected from the primary side. Of course, this means that some sort of load detector is required to determine whether a load is connected and to switch between active and standby modes appropriately.

In an AC-DC linear power supply, the load detector can be rather simple and various load detectors have been developed, one of which is described in U.S. Pat. No. 5,624,305. This is because, firstly, it is easier to measure and monitor conditions in DC and to detect any relevant changes due to the presence or absence of a load. Further, the load detection circuit needs some power, in the form of DC, to function. This is readily available for the DC case but not for the AC case. Finally, for the AC-AC case, the load detection circuitry will have to be coupled to the secondary winding of the transformer. The secondary winding tends to present a closed circuit to whatever circuitry that is implemented and is a short circuit for DC and low frequencies. For the AC-DC case, however, the filter capacitor decouples the power supply from the load and so a load detection circuit can be placed in between.

[symbol]

Although an AC-DC linear power supply can mean a rather simple load detector, an AC-DC linear power supply does have the disadvantage that the efficiency during active mode can be quite low because of the presence of the rectifier.

Thus, an AC-AC power supply may be preferred. However, in an AC-AC power supply, the load detector cannot be so straightforward, because the power being supplied to the load is AC i.e. fluctuating between zero and a maximum, so it is much more difficult to determine whether or not a load is connected. One way to detect a load for the AC case is to detect the AC current drawn by the load using a current sense transformer, which translates a current flow to a voltage signal. However, as the frequency of the AC power source is low (typically 50 or 60 Hz), such transformers tend to be bulky and costly. Also, for light loads that do not draw much power, the current sense transformer will have to be made quite sensitive, by increasing the number of turns in the transformer windings. Further, when the load is not constant, this operation of the current sense transformer will be even more complicated.

### SUMMARY OF THE INVENTION

According to a first aspect of the invention, there is provided a load detector for determining whether a load is connected to an AC-AC power supply, the power supply comprising a transformer having a primary winding and a secondary winding, the primary winding being coupleable to an AC voltage supply via a switch, and the secondary winding being coupleable to a load, the load detector comprising:
a signal generator for generating a signal;
a sensor for detecting the signal, the sensor being arranged to detect the signal if a load is coupled to the secondary winding and to not detect the signal if a load is not connected to the secondary winding; and
switch control circuitry coupled to the sensor and being arranged to keep the switch closed if the sensor is detecting the signal and to keep the switch open if the sensor is not detecting the signal.

Thus, the load detector is arranged to determine whether a load is connected to the secondary winding of the power supply, and to open and close the switch between the AC voltage supply and the primary winding of the power supply appropriately. Thus, when a load is connected so that the sensor is detecting the signal, the load detector keeps the switch between the primary winding and the AC voltage supply closed, so that the AC voltage supply can deliver power to the load. However, when a load is not connected so that the sensor is not detecting the signal, the load detector keeps the switch between the primary winding and the AC voltage supply open.

The signal generator is preferably connectable across the secondary winding of the transformer of the AC-AC power supply.

Preferably, when the signal generator is connected across the secondary winding and a load is coupled to the secondary winding, a closed path is formed from the signal generator back to the signal generator via the load and the sensor. Because a closed path is formed via the load and the sensor, the signal generated by the signal generator can be detected by the sensor. Thus, the presence of the load, which results in the closed circuit, means that the switch control circuitry of the load detector keeps the switch on the primary side of the AC-AC power supply closed.

Preferably, when the signal generator is connected across the secondary winding and no load is connected to the output nodes, no closed path is formed from the signal generator back to the signal generator. Because no closed path is formed, the signal generated by the signal generator cannot be detected by the sensor. Thus, when no closed path is formed, the switch control circuitry of the load detector keeps the switch on the primary side of the AC-AC power supply open.

In one preferred embodiment, the signal generator is arranged to generate a pulsed signal. This is advantageous because a pulsed signal comprises high frequency content. The signal generator may generate a pulsed signal by repeatedly charging and discharging a capacitor, thus providing a pulsed voltage at an output node.

The sensor may comprise a transformer for locating between the secondary winding of the AC-AC power supply and an output node for a load. The primary winding of the transformer may form part of the connection between the secondary winding and the load output node. The secondary winding may be connected to the circuitry for controlling the switch.

The switch may comprise a relay. In that case, the switch control circuitry may be coupled to the relay such that, when the sensor is detecting a signal, current flows through the coil of the relay, closing the switch between the AC power supply and the primary winding, and, when the sensor is not detecting a signal, no current flows through the coil of the relay, and the switch between the AC power supply and the primary winding remains open.

According to a second aspect of the invention, there is provided an AC-AC power supply for a load, the power supply comprising:
a transformer comprising a primary winding and a secondary winding, the primary winding being coupleable to an AC voltage supply via a switch, and the secondary winding being coupled to output nodes for a load, via a load detector, the load detector comprising:
a signal generator for generating a signal;
a sensor for detecting the signal, the sensor being arranged to detect the signal if a load is connected to the output nodes and to not detect the signal if a load is not connected to the output nodes; and
switch control circuitry coupled to the sensor and being arranged to keep the switch closed if the sensor is detecting the signal and to keep the switch open if the sensor is not detecting the signal.

Thus, the load detector in the power supply is arranged to determine whether or not a load is connected to the secondary winding of the power supply, and to open and close the switch on the primary side appropriately. When a load is connected and the sensor is detecting the signal, the switch between the primary winding and the AC voltage supply is kept closed so that the AC voltage supply can deliver power to the load. Then, the power supply is in active mode. However, when a load is not connected, and the sensor is not detecting the signal, the switch between the primary winding and the AC voltage supply is kept open. Then, the power supply is in no-load mode.

In one embodiment, the signal generator is connected across the secondary winding. In that embodiment, the power supply is preferably arranged such that, when a load is connected to the output nodes, a closed path is formed from the signal generator back to the signal generator via the load and the sensor. Because a closed path is formed via the load and the sensor, the signal can be detected by the sensor. Thus, the presence of a load, which results in the closed circuit, means that the circuitry keeps the switch on the primary side closed. In that embodiment, the power supply is also preferably arranged such that, when no load is connected to the output nodes, no closed path is formed from the signal generator back to the signal generator. Because no closed path is formed, the signal cannot be detected by the sensor. Thus, when there is no load connected at the output nodes so that no closed path is formed, the circuitry keeps the switch on the primary side open.

The signal generator may be arranged to generate a pulsed signal. This is advantageous because a pulsed signal comprises high frequency content. If the signal generator is connected across the secondary winding, a pulsed signal is particularly advantageous because the high frequency content of the pulsed signal will mean that the secondary winding presents a high impedance to the pulsed signal. Thus, the secondary winding will not provide a closed path for the pulsed signal from and to the signal generator, which could mean that the sensor accidentally detects the signal even when no load is connected at the output nodes. The signal generator may generate a pulsed signal by repeatedly charging and discharging a capacitor, thus providing a pulsed voltage at an output node.

The sensor may comprise a transformer between the secondary winding and one of the output nodes. The primary winding of the transformer may form part of the connection between the secondary winding and the output node. The secondary winding may be connected to the circuitry for controlling the switch.

The switch may comprise a relay. In that case, the switch control circuitry may be coupled to the relay such that, when the sensor is detecting a signal, current flows through the coil of the relay, closing the switch between the AC power supply and the primary winding and, when the sensor is not detecting a signal, no current flows through the coil of the relay, and the switch between the AC power supply and the primary winding remains open.

In a first embodiment, the power supply further comprises a standby power supply for supplying power to the signal generator when no load is connected to the output nodes. Thus, when a load is connected to the output nodes, power for the signal generator is supplied by the AC voltage supply and, when no load is connected to the output nodes, power for the signal generator is supplied by the standby power supply. The standby power supply is preferably connectable to the AC power supply.

In a second embodiment, the power supply further comprises a capacitor across the switch. In this second embodiment, when the switch is closed, the AC power supply is connected directly to the primary winding, bypassing the capacitor, and, when the switch is open, the AC power supply is connected to the primary winding via the capacitor. Thus, when the switch is open (i.e. no load is connected to the output nodes on the secondary side), power is still delivered to the secondary side, but the amount of power can be controlled by suitable choice of the value of the capacitor.

In the second embodiment, the power supply may further comprise a connection from the secondary winding to the signal generator, via a rectifier, for supplying DC power to the signal generator when no load is connected to the output nodes.

According to a third aspect of the invention, there is provided a method for detecting whether a load is connected to an AC-AC power supply, the power supply comprising a transformer having a primary winding and a secondary winding, the primary winding being coupleable to an AC voltage supply via a switch, and the secondary winding being coupleable to a load, the method comprising the steps of:
generating a signal on the secondary side of the transformer;
if a load is coupled to the secondary winding, detecting the signal and, in response to the detected signal, keeping the switch between the primary winding and the AC voltage supply closed;
if no load is coupled to the secondary winding, not detecting the signal and, in response to no detected signal, keeping the switch between the primary winding and the AC voltage supply open.

Features described in relation to one aspect of the invention may also be applicable to other aspects of the invention.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, of which:

FIG. 1 shows a first embodiment of the invention;

FIG. 2 shows a second embodiment of the invention;

FIG. 3 shows one possible circuit implementation of the embodiment of FIG. 2;

FIG. 4 is a plot of the voltage at node 313 with respect to time, for the arrangement shown in FIG. 3; and

FIG. 5 is a plot of the voltage at node 315 with respect to time, for the arrangement shown in FIG. 3.

### DETAILED DESCRIPTION OF PREFERRED EMBODIMENTS

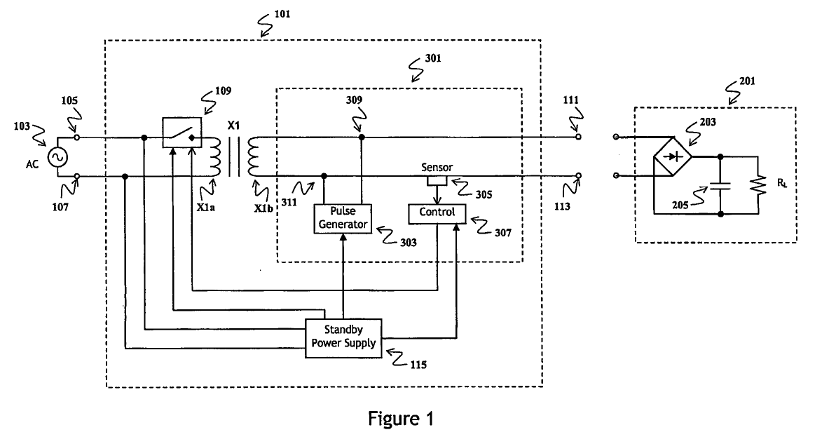

FIG. 1 is a diagram of a first embodiment of the invention. Referring to FIG. 1, AC-AC linear power supply 101 comprises a transformer X1. The primary winding X1a of the transformer X1 is connectable to the AC power supply 103 at nodes 105 and 107, via a switch 109. The AC power supply may be any AC voltage at any frequency e.g. 110VAC, 120VAC, 230VAC or 240VAC at 50 or 60 Hz. The secondary winding X1b of the transformer X1 is connectable to a load 201 (shown disconnected in FIG. 1) at nodes 111 and 113 (normally via a cable and connector) via load detector 301. The AC-AC linear power supply 101 also includes a standby power supply 115.

The switch 109, between primary winding X1a and AC power supply 103, is for switching on and off the AC power supply 103 to the transformer X1. The switch 109 may be any suitable type of switch for example a relay or an optocoupler. Switch 109 is controlled by control 307 (to be described below) in load detector 301.

The load detector 301, between secondary winding X1b and nodes 111 and 113, comprises pulse generator 303, sensor 305 and control 307. The pulse generator 303 is connected across the secondary winding X1b of transformer X1 at nodes 309 and 311. Sensor 305 is connected to the line between one side of the secondary winding X1b and the output node 113. As already mentioned, control 307 controls switch 109. The control 307 receives an input from sensor 305. The control is arranged to keep the switch 109 closed only if a load is present. If no load is connected to nodes 111 and 113, the switch 109 is open.

The load 201 typically comprises a rectifier 203 and a filter capacitor 205 to convert the AC voltage to a DC voltage for the load R_{L}.

Operation of the arrangement of FIG. 1 will now be described.

Consider a first stage, when the AC-AC power supply 101 is connected to the AC input 103 at nodes 105 and 107 but there is no load connected on the secondary side of the circuit to nodes 111 and 113. Since there is no load connected, we are in standby or no-load mode. At this stage, switch 109 is open so standby power supply is providing power for the pulse generator 303 and the control 307. Pulse generator 303 receives power from standby power supply 115 and starts to send a pulsed signal through node 309 to check for the presence of a load at nodes 111 and 113. Since, at this stage, no load is connected to nodes 111, 113, the circuit is open, so no return path is provided for the pulsed signal so no signal is picked up by sensor 305.

Then, in a second stage, a load (like 201 for example) is connected at nodes 111 and 113. The pulse generator 303 is still sending its pulsed signal to node 309, but now there is a load at nodes 111 and 113 so the circuit is closed. Thus, the load 201 provides the return path for the pulse from 309 to 311, via rectifier 203 and capacitor 205. Therefore, a signal is picked up by sensor 305. Once sensor 305 detects the pulsed signal indicating that a load is present at nodes 111 and 113, it sends a signal to control 307, which then closes switch 109. Thus, primary winding X1a of the transformer X1 is now connected to the AC power supply 103 so that the AC power supply 103 can deliver power to the load at nodes 111, 113. Thus, we are now in active mode.

Then, in a third stage, the load 201 is again disconnected from nodes 111, 113. Because the circuit is now open again, the pulsed signal is no longer picked up by sensor 305. Once sensor 305 no longer detects the pulsed signal (indicating that the load has been disconnected), it sends a signal to control 307 to open the switch 109. Once switch 109 is open, primary side X1a of transformer X1 is no longer connected to the AC power supply 103. This returns the AC-AC power supply to standby mode once again, with standby power supply 115 supplying power for the circuit.

The standby power supply 115 is connected to the AC power supply before the switch 109. Thus, even when switch 109 is open, the standby power supply is still connected to the AC power supply so as to be able to provide power to the pulse generator 303 and to the control 307. When the AC-AC power supply is in standby mode, the standby mode power supply 115 should preferably deliver just enough power for load detector 301 and switch 109 to function properly. This minimizes the power consumption during standby mode.

A pulsed signal is used to check for the presence of a load at nodes 111 and 113 because it has high frequency content. When a load is connected to nodes 111 and 113, the secondary winding X1b of the transformer X1, which is an inductor, will be seen as high impedance to the pulsed signal from pulse generator 303, whereas the load 201 will be seen as low impedance to the pulsed signal. Thus, most of the pulsed signal from pulse generator 303 via node 309 will pass through the load 201 and return to the pulse generator 303 via node 311, so that the sensor 305 will detect the signal.

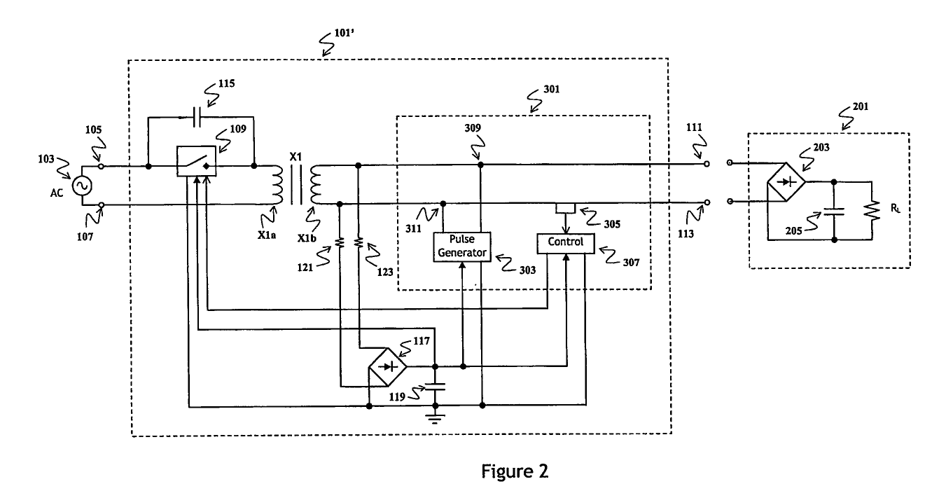

FIG. 2 is a diagram of a second embodiment of the invention. The arrangement of FIG. 2 is very similar to that of FIG. 1. The only difference is the way in which power is supplied to the load detector 301 and to the switch 109. As in FIG. 1, AC-AC linear power supply 101′ comprises a transformer X1. The primary winding X1a of the transformer X1 is connectable to the AC power supply 103 at nodes 105 and 107, via a switch 109. In the FIG. 2 arrangement, there is also a capacitor 115 across switch 109. Once again, the AC power supply may be any AC voltage at any frequency. The secondary winding X1b of the transformer X1 is connectable to a load 201 (shown disconnected in FIG. 2) at nodes 111 and 113, via load detector 301. The AC-AC linear power supply of FIG. 2 also includes a rectifier 117 and filter capacitor 119 connected across the secondary winding X1b, via resistors 121 and 123.

As in the FIG. 1 arrangement, the switch 109, between primary winding X1a and AC power supply 103, is for connecting and disconnecting the transformer X1 directly to the AC power supply 103. However, in FIG. 2, because there is a capacitor 115 across switch 109, when switch 109 is closed, the AC power supply 103 is connected directly to the transformer X1, whereas, when switch 109 is open, the AC power supply 103 is connected to transformer X1, but only via capacitor 115. This will be described further below. As before, switch 109 may be any suitable type of switch, for example a relay or an optocoupler.

The load detector 301, between secondary winding X1b and load 201, of FIG. 2 is identical to that of FIG. 1. That is, the load detector 301 comprises pulse generator 303, connected across the secondary winding X1b at nodes 309 and 311, sensor 305, connected to the line between one side of the secondary winding X1b and the load 201, and control 307, for controlling switch 109 and receiving input from sensor 305. As before, the control is arranged to keep the switch 109 closed only if a load is connected at nodes 111 and 113. If no load is connected, the switch 109 is open.

The load 201 may also be identical to the load in the FIG. 1 arrangement. That is, load 201 comprises a rectifier 203 and a filter capacitor 205, to convert the AC voltage to a DC voltage for the load, represented by R_{L}.

Operation of the arrangement of FIG. 2 will now be described.

Consider a first stage, in which the AC-AC power supply 101 is connected to AC power supply 103 at nodes 105 and 107, and there is a load connected at nodes 111 and 113. Since there is a load connected, we are in active mode. As in the FIG. 1 arrangement, the pulse generator is sending its pulsed signal to node 309. Because the circuit is closed by load 201, the load 201 provides the return path for the pulsed signal from node 309 to node 311 via rectifier 203 and capacitor 205. Therefore, the pulsed signal is picked up by sensor 305, which sends a signal to control 307, which keeps switch 109 closed. So, the AC power supply 103 is connected directly to the transformer X1 (bypassing capacitor 115) so that the AC power supply 103 is providing power for the load 201 at nodes 111, 113. Power for the load detector 301 and switch 109 is taken from the secondary side of the transformer X1 after conversion to DC by rectifier 117 and filter capacitor 119.

Then, in a second stage, the load is disconnected from nodes 111 and 113. Thus, the circuit is now open, no return path is provided for the pulsed signal from pulse generator 303 and no signal is picked up by the sensor 305. Thus, control 307 opens switch 109. Now, the primary winding X1a of transformer X1 is connected to the AC power supply 103 via capacitor 115. Capacitor 115 acts as a current limiter, limiting the current, and effectively the power, to the primary side X1a of transformer X1. Since the load 201 is disconnected, we are in standby mode and only a small amount of power is required to keep the load detector operational. The exact amount of power supplied, can be selected by appropriate choice of capacitor 115. Ideally, the capacitor should deliver just enough power for load detector 301 and switch to function properly. Power for the load detector is still provided from the secondary side of the transformer X1, after conversion to DC by the rectifier 117 and filter capacitor 119.

The resistors 121 and 123 are included to provide a high impedance to the pulsed signal from pulse generator 303 and hence prevent the pulsed signal taking this path. Inductors could be used as an alternative to resistors 121, 123.

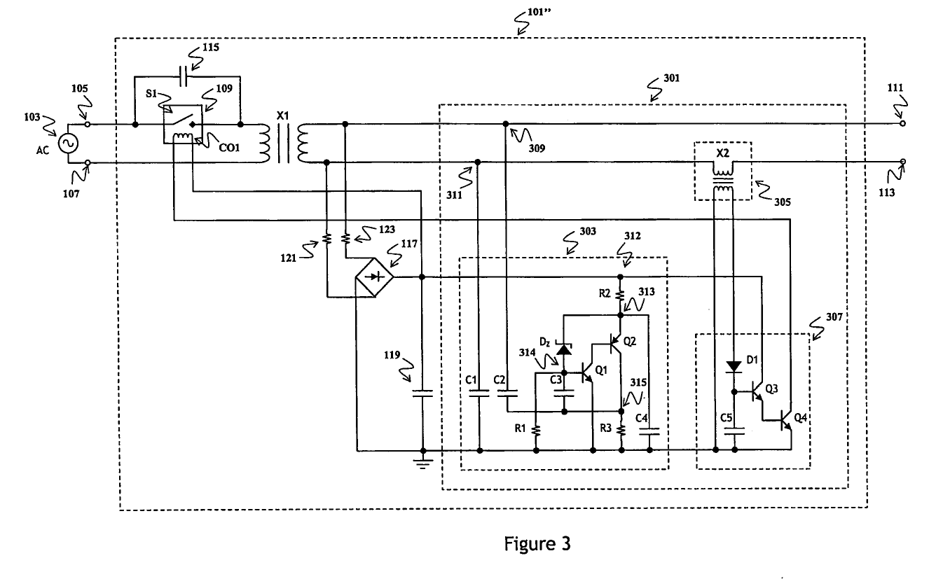

FIG. 3 is a diagram of the second embodiment of the invention (as previously shown in FIG. 2) but with possible circuitry of the pulse generator 303, the sensor 305, the control 307 and the switch 109 shown. The rest of the circuit is exactly the same as shown in FIG. 2 and will not be described further. The load 201 is not shown in FIG. 3. Note that the circuitry shown in FIG. 3 is only an example of possible circuitry for the FIG. 2 arrangement. The skilled person will appreciate that any alternative suitable circuitry could be used instead.

Referring to FIG. 3, the circuitry of the pulse generator is shown in box 303. The pulse generator comprises transistors Q1 and Q2, resistors R1, R2 and R3, capacitors C1, C2, C3 and C4 and zener diode D_{Z}. Operation of the pulse generator is as follows.

Power to the pulse generator at node 312 is DC, after the rectifier 117 and filter capacitor 119. At the beginning of a cycle, the voltage at node 313 is lower than the breakdown voltage of D_{Z}. The voltage at node 314 is therefore at ground potential and transistors Q1 and Q2 are off. As C4 continues to charge up, the voltage at node 313 rises. Once the voltage at node 313 has risen sufficiently, is the zener diode D_{Z} will start to conduct and the voltage at node 314 will start to rise. Once the voltage at node 314 has risen sufficiently, Q1 and Q2 will switch on. As Q2 switches on, the voltage at node 315 rises rapidly. The increase in voltage at node 315 is translated back to node 314 through capacitor C3. This results in positive feedback. A discharge path for C4 is created due to the switching on of Q2. Because of positive feedback, C4 is rapidly discharged, causing the voltage at node 313 to drop very quickly. This causes the voltage at node 314 to drop, switching off Q1 and Q2. As Q2 is switched off, the voltage at node 315 drops back to ground potential. Due to this short-lived switching on and off of the transistors, a voltage pulse is seen at node 315. This pulse is coupled to node 309 via capacitor C2. If a load is present across nodes 111 and 113, this pulse will go through the load and return to ground at node 311 via capacitor C1. As transistors Q1 and Q2 are turned off, C4 will start to charge up again so that the cycle repeats.

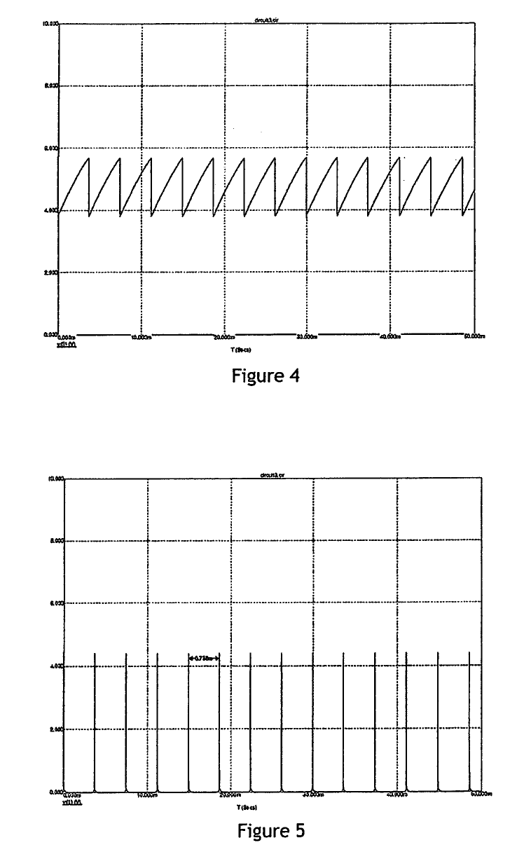

The voltage at node 313 has the form shown in FIG. 4 and the voltage at node 315 has the form shown in FIG. 5.

Referring once again to FIG. 3, the circuitry of the sensor is shown in box 305. The sensor is simply a transformer X2. The primary winding of the transformer X2 forms part of the line from the secondary winding X1b of transformer X1 through node 311 to load output node 113. The secondary winding of the transformer X2 is connected to the control 307. When no load is connected at output nodes 111, 113, no return path for the pulsed signal is provided, so no pulse is picked up at the primary winding. On the other hand, when a load is connected at output nodes 111, 113, the pulse is picked up at primary winding of transformer X2 and hence at the secondary winding of transformer X2.

Referring once again to FIG. 3, the circuitry of the control is shown in box 307 and the circuitry of the switch is shown in box 109. The control comprises transistors Q3 and Q4, diode D1 and capacitor C5. The switch comprises a relay having a switch S1 and a coil CO1. With each current peak through the secondary winding of X2, the capacitor C5 charges up a little. Once capacitor C5 has charged up sufficiently to switch on transistor Q3, current starts to flow from rectifier 117, through the coil CO1 and through transistors Q3 and Q4. The current through the coil CO1 causes switch S1 to close. When the load is disconnected so that there are no current peaks through the secondary winding of X2, the voltage across capacitor C5 begins to fall, until the transistor Q3 is switched off. Then, there is no current through the coil CO1 and the switch S1 opens.

1. A load detector for determining whether a load is connected to an AC-AC power supply, the power supply comprising a transformer having a primary winding and a secondary winding, the primary winding being coupleable to an AC voltage supply via a switch, and the secondary winding being coupleable to a load, the load detector comprising:
a signal generator for generating a signal;
a sensor for detecting the signal, the sensor being arranged to detect the signal if a load is coupled to the secondary winding and to not detect the signal if a load is not coupled to the secondary winding; and
switch control circuitry coupled to the sensor and being arranged to keep the switch closed if the sensor is detecting the signal and to keep the switch open if the sensor is not detecting the signal.

2. The load detector of claim 1, wherein the signal generator is connectable across the secondary winding of the transformer of the AC-AC power supply.

3. The load detector of claim 2, wherein, when the signal generator is connected across the secondary winding and a load is coupled to the secondary winding, a closed path is formed from the signal generator back to the signal generator via the load and the sensor.

4. The load detector of claim 2, wherein, when the signal generator is connected across the secondary winding and no load is coupled to the secondary winding, no closed path is formed from the signal generator back to the signal generator.

5. The load detector of claim 1, wherein the signal generator is arranged to generate a pulsed signal.

6. An AC-AC power supply for a load, the power supply comprising:
a transformer comprising a primary winding and a secondary winding, the primary winding being coupleable to an AC voltage supply via a switch, and the secondary winding being coupled to output nodes for a load, via a load detector, the load detector comprising:
a signal generator for generating a signal;
a sensor for detecting the signal, the sensor being arranged to detect the signal if a load is connected to the output nodes and to not detect the signal if a load is not connected to the output nodes; and
switch control circuitry coupled to the sensor and being arranged to keep the switch closed if the sensor is detecting the signal and to keep the switch open if the sensor is not detecting the signal.

7. The power supply of claim 6, wherein the signal generator is connected across the secondary winding.

8. The power supply of claim 7, wherein, when a load is connected to the output nodes, a closed path is formed from the signal generator back to the signal generator via the load and the sensor.

9. The power supply of claim 7, wherein, when no load is connected to the output nodes, no closed path is formed from the signal generator back to the signal generator.

10. The power supply of claim 6, wherein the signal generator is arranged to generate a pulsed signal.

11. The power supply of claim 6, further comprising a standby power supply for supplying power to the signal generator when no load is connected to the output nodes.

12. The power supply of claim 6, further comprising a capacitor across the switch.

13. The power supply of claim 12, further comprising a connection from the secondary winding to the signal generator, via a rectifier, for supplying power to the signal generator when no load is connected to the output nodes.

14. A method for detecting whether a load is connected to an AC-AC power supply, the power supply comprising a transformer having a primary winding and a secondary winding, the primary winding being coupleable to an AC voltage supply via a switch, and the secondary winding being coupleable to a load, the method comprising the steps of:
generating a signal on the secondary side of the transformer;
if a load is coupled to the secondary winding, detecting the signal and, in response to the detected signal, keeping the switch between the primary winding and the AC voltage supply closed;
if no load is coupled to the secondary winding, not detecting the signal and, in response to no detected signal, keeping the switch between the primary winding and the AC voltage supply open.
